(19) United States
(12) Patent Application Publication
(10) Pub. No.: US 2011/0134065 A1
(43) Pub. Date: Jun. 9, 2011

(54) Notebook Computer with Hidden Touch Sensitive Unit

(75) Inventor: Kuo-Jung Hsu, Taipei (TW)

(73) Assignee: ASUSTEK COMPUTER INC., Taipei (TW)

(21) Appl. No.: 13/018,552

(22) Filed: Feb. 1, 2011

Related U.S. Application Data
(63) Continuation-in-part of application No. 10/661,587, filed on Sep. 15, 2003, now Pat. No. 7,898,528.

(30) Foreign Application Priority Data
Jan. 15, 2003 (TW) 92100759

(51) Int. Cl. G06F 3/041

(52) U.S. Cl. 345/173

(57) ABSTRACT

A notebook computer includes a main portion, a display, and a touch sensitive unit. The main portion includes a housing has a first identifying portion formed on an external surface and a second identifying portion formed on an internal surface that corresponding to each other. The second identifying portion is identifiably served, and the touch sensitive unit is disposed in the second identifying portion. With such manner, the touch sensitive unit is thus unexposed, and assembling of the touch sensitive unit is facilitated.

### CROSS-REFERENCE

The present application is a continuation-in-part application of U.S. application Ser. No. 10/661,587, filed Sep. 15, 2003, and claims priority to Taiwanese Application Serial Number 92100759, filed Jan. 15, 2003. The entire disclosures of all the above applications are hereby incorporated by reference herein.

### FIELD OF THE INVENTION

The invention relates to a notebook computer and a manufacturing method thereof; in particular, to a notebook computer with a hidden touch sensitive unit.

### BACKGROUND OF THE INVENTION

A touch pad is a necessary component in most portable computers. By means of the touch pad, the user is able to control the cursor and otherwise interact with the computer.

As shown in FIG. 1a and FIG. 1b, a touch pad 14 is disposed in a conventional portable computer 10. An aperture 13 is formed on a housing 12 of a main portion 11 so as to expose the touch pad 14 for the user to operate it. That is, to expose the touch pad 14, the housing 12 must be provided with the aperture 13.

Furthermore, during manufacture, the touch pad 14 is disposed in the main portion 11 by an engaging member 15.

However, since the top portion of the housing is provided with the aperture, water or external vapor would flow into the main portion through the aperture. Furthermore, since the touch pad is exposed for conveniently use, dust might also be accumulated on the touch pad. Thus, the performance of the touch pad deteriorates. Besides, since a touch sensitive unit of the touch pad is disposed in an inner surface of the main portion, it is very difficult for a fabricator to know where to install the touch pad that would substantially corresponds to a manipulation area.

### SUMMARY OF THE INVENTION

A notebook computer with touch sensitive unit is provided. The notebook computer comprises an identifying structure includes a first identifying portion formed on a first surface of a housing and a second identifying portion corresponding to the first identifying portion formed on the second surface of the housing.

Accordingly, it is provided a notebook computer comprising: a display; a main portion connected with the display and including a housing, wherein the housing includes at least a portion that has a first surface and a second surface, a first identifying portion formed on the first surface and a second identifying portion corresponding to the first identifying portion formed on the second surface and not exposed to the first surface; and a touch sensitive unit located in the second identifying portion.

In an embodiment, the second identifying portion is a concave structure formed on the second surface.

In an embodiment, a thickness of the housing of the concave structure formed therein is about 0.5-0.8 mm.

In an embodiment, a difference between a thickness of the housing that the concave structure forms therein and a thickness of the housing that the concave structure does not form therein is 0.7-1.0 mm.

In an embodiment, a ratio between a thickness of the housing that the concave structure forms therein and a thickness of the housing that the concave structure does not form therein is ⅓-½.

In an embodiment, at least one holding protrusion is formed on the second surface adjacent to the second identifying portion, the holding protrusion facilitates identification of the second identifying portion and fits with and engages the touch sensitive unit.

In an embodiment, the first identifying portion includes a plurality of identifying dots that formed on the first surface of the housing and are arranged in matrix, the identifying dots may be protrusions or indentations on the first surface.

In an embodiment, the first identifying portion is made of a thermochromic material.

In an embodiment, the first identifying portion is surrounded by a flange formed on the housing.

In an embodiment, the first identifying portion presents as a mark that formed on the housing.

In an embodiment, a plurality of illumination element that are deposited on the second surface and surrounding the second identifying portion, the thickness of the housing that the illumination elements form therein is thinned for the light from the illumination elements to pass through the housing for identification of the first identifying portion and second identifying portion corresponding thereto.

A notebook computer is also provided, comprising: a display; a main portion connected with the display and including a housing, wherein the housing has a first surface and a second surface, a first identifying portion formed on the first surface and a second identifying portion corresponding to the first identifying portion formed on the second surface; and a touch sensitive unit disposed in the second identifying portion.

Furthermore, the housing has a plurality of through holes communicating the first identifying portion and the second identifying portion. An interface member is disposed on the second surface and couple with the touch sensitive unit, and has a top surface attached to the second surface, portions of the interface member that corresponding to and exposed through the through holes pass through the holes and protrudes from the first surface. With such manner, a user may touch the interface member on the first identifying portion, and force applied may transmitted to the sensitive unit via the interface member.

Accordingly, the present invention provides the first identification portion formed on the first surface and the second identification portion formed on the second surface that correspond to each other, thereby facilitating identification of an operation area corresponding to the touch sensitive unit. A user can clearly know an operation area corresponding to the touch sensitive unit and easily install the touch sensitive unit.

### BRIEF DESCRIPTION OF THE DRAWINGS

The present invention can be more fully understood by reading the subsequent detailed description and examples with references made to the accompanying drawings, wherein:

FIG. 1a is a schematic view of a conventional notebook computer;

FIG. 1b is a cross section along a line b-b in FIG. 1a;

FIG. 2a is a partial exploded view of a notebook computer as disclosed in this invention;

FIG. 2b is a schematic view of a notebook computer as disclosed in this invention;

FIG. 2c is a partial top view of a housing in FIG. 2b;

FIG. 2d is a cross section along a line d-d in FIG. 2c;

FIG. 2e is a partially enlarged view of a touch sensitive unit and a second identifying portion in FIG. 2d;

FIG. 2f is a cross sectional diagram of the housing;

FIG. 2g is a schematic diagram of a first surface of the housing according to an embodiment;

FIG. 2h is a schematic diagram of a first surface of the housing according to another embodiment.

FIG. 2i is a cross-section diagram from the line AA′ in the FIG. 2h that illustrates illumination elements disposed on the second surface of the housing;

FIG. 2j illustrates the housing has a first part that be made of thermochromic material;

FIG. 2k illustrates a plurality of exposed portions passes through the holes and protrude from the first surface; and

FIG. 3 is a flow chart showing a method for manufacturing a notebook computer as disclosed in this invention.

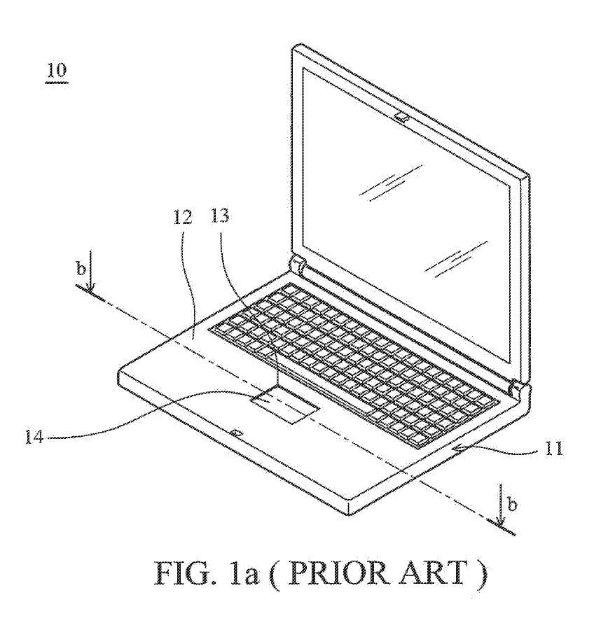

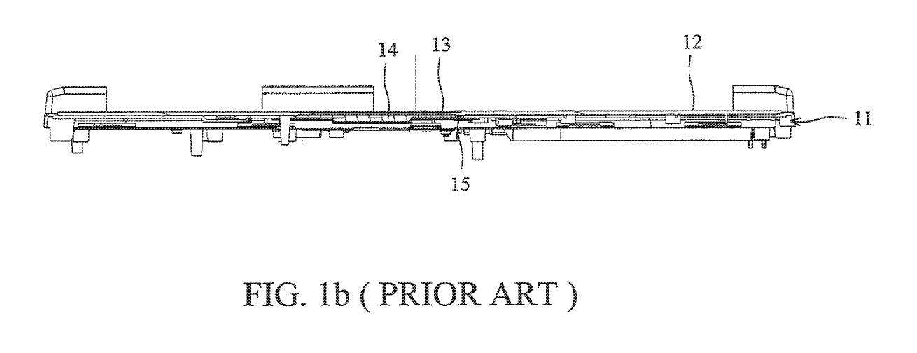

### DETAILED DESCRIPTION OF THE INVENTION

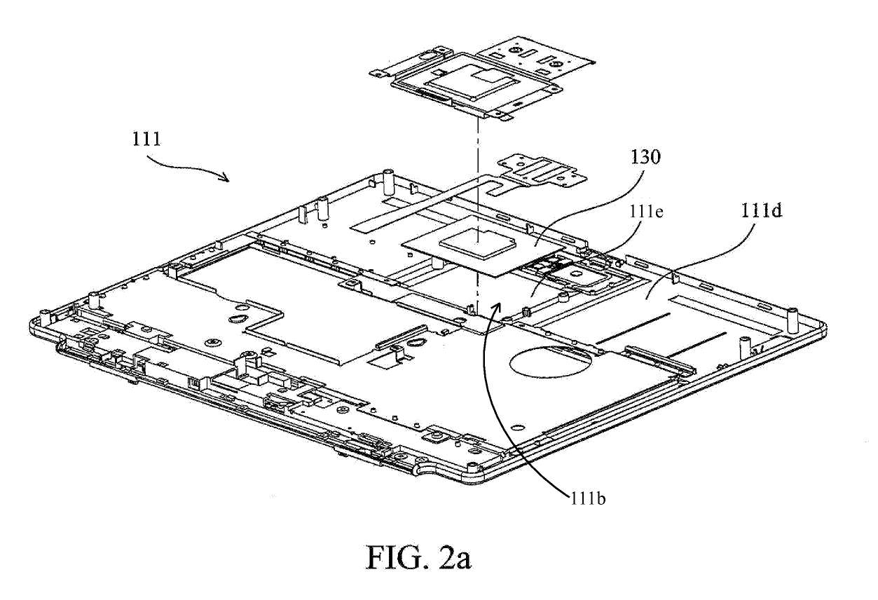

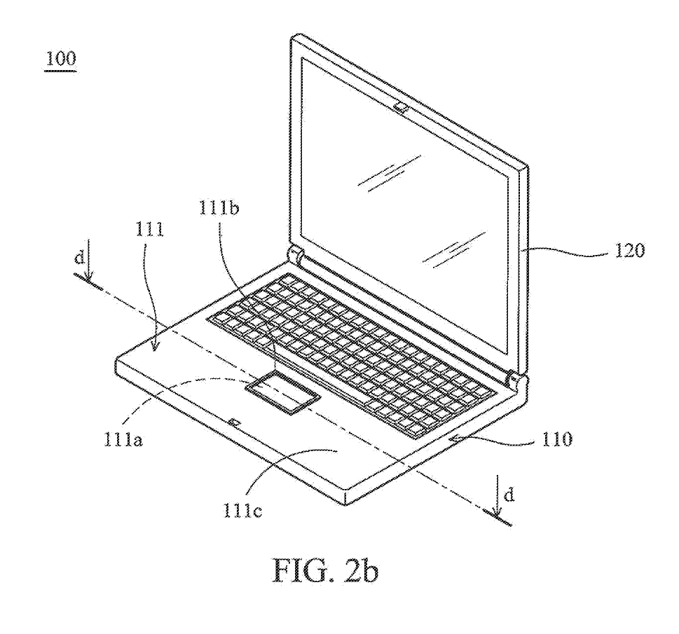

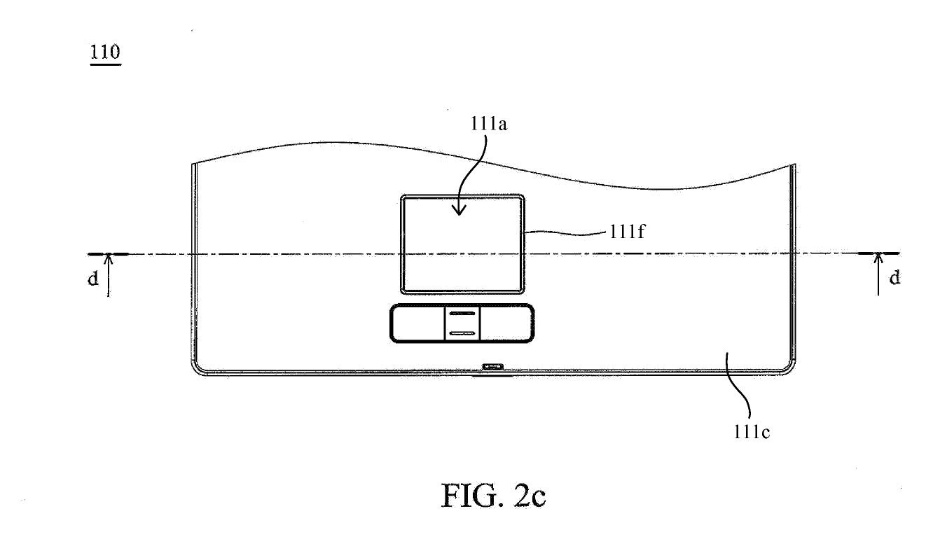

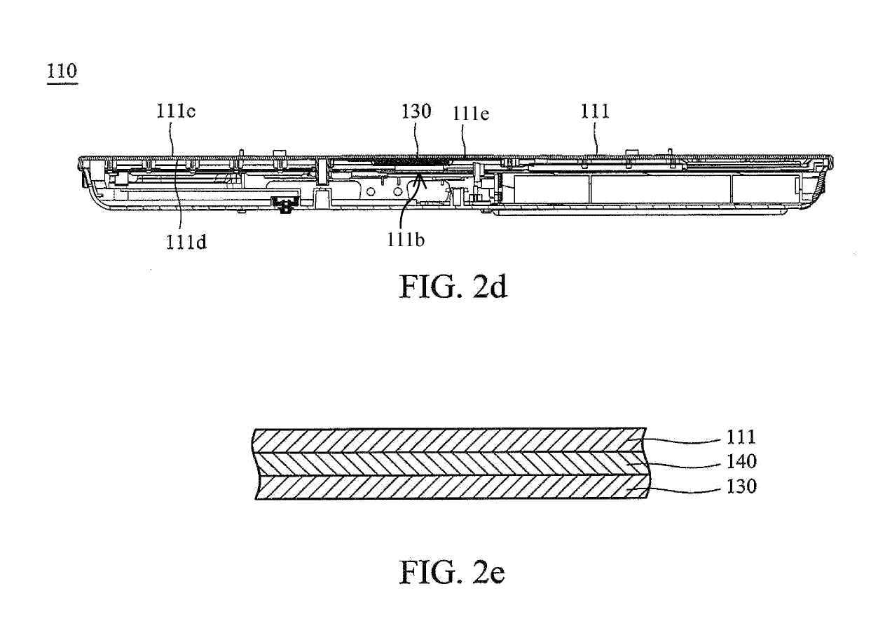

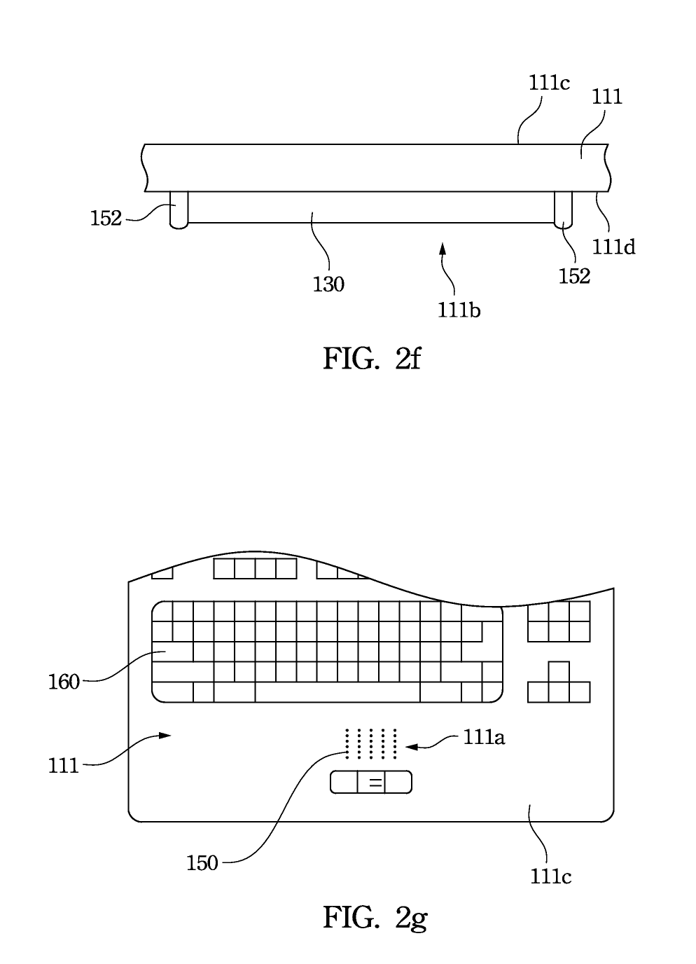

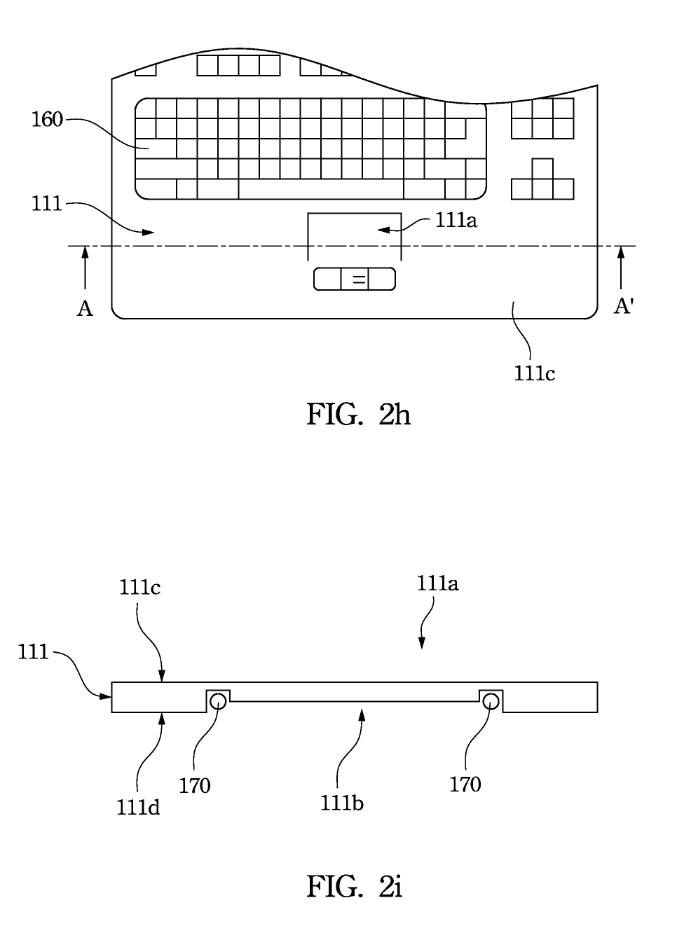

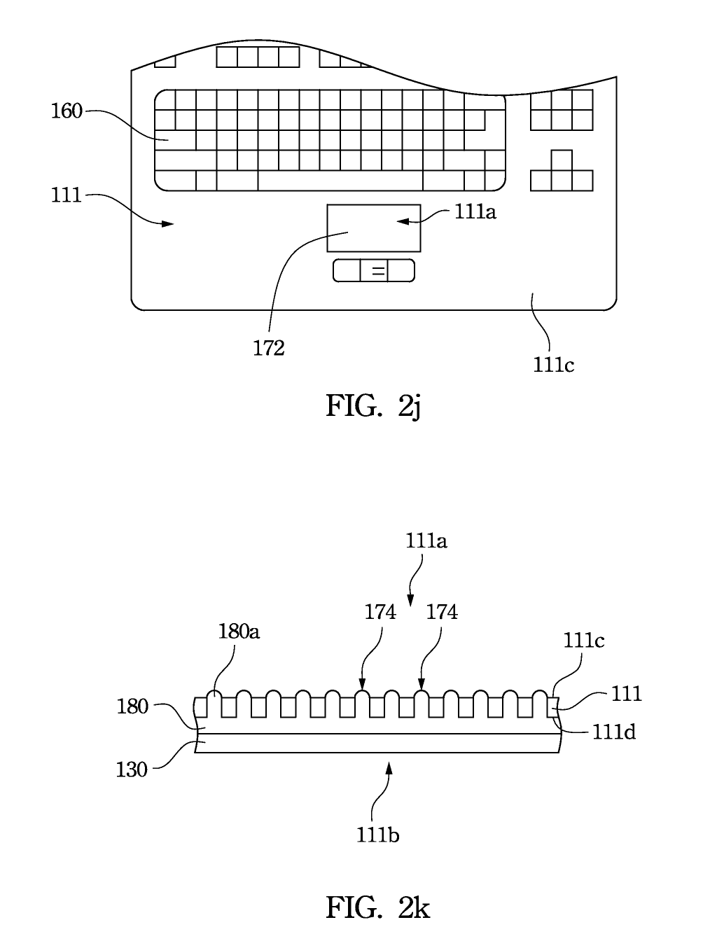

Referring to FIG. 2a, FIG. 2b, FIG. 2c, and FIG. 2d, a notebook 100 with a surface mounted touch sensitive unit as disclosed in this invention is provided. The notebook computer 100 includes a main portion 110, a display 120, and a touch sensitive unit 130.

The main portion 110 is a basic component of the notebook computer 100, and is provided with necessary devices required by the notebook computer 100 therein. In addition, the main portion 110 includes a housing 111 as shown in FIG. 2b. Referring to FIG. 2b and FIG. 2d, the housing 111 includes a first surface 111c (the external surface) and a second surface 111d (the internal, and unexposed surface) on the underside of the first surface 111c. A second identifying portion 111b is formed on the second surface 111d. The touch sensitive unit 130 is disposed in the second identifying portion 111b.

The second identifying portion 111b may be in various styles. In an embodiment, the second identifying portion 111b is a concave structure 111e that facilitates identification as shown in FIG. 2a and FIG. 2d. By the concave structure 111e, an operation area corresponding to the touch sensitive unit 130 on the second surface 111d is simply identified. That is, a fabricator can easily install the touch sensitive unit 130 on the position of the second identifying portion 111b according to its concave structure.

Moreover, in a further embodiment, the second identifying portion 111b is surrounded by a holding protrusion 152 as shown in FIG. 2f. The holding protrusion 152 protrudes from the second surface 111d adjacent to the second identifying portion, and is fit with and to engage the touch sensitive unit 130 on the second identifying portion 111b. In other words, in this embodiment, the second identifying portion 111b is identified by the holding protrusion 152. Based on the holding protrusion 152, a fabricator can know the position to install the touch sensitive unit 130. Accordingly, the second identifying portion 111b on the second surface 111d may have, but not limited to, the concave structure 111e mentioned above or the holding protrusion 152. It is noted that when the second identifying portion 111b is a concave structure, the thickness of the housing 111 at the second identifying portion 111b is thinner that of a portion adjacent to the second identifying portion 111b, of the housing 111. Thus, the touch sensitive unit 130 is more sensitive and performance thereof is enhanced. For example, when the standard thickness of the housing 111 is 1.5 mm, the thickness of the housing 111 at the second identifying portion 111b may be 0.5-0.8 mm. That is, the difference between the thickness of the housing 111 at the second identifying portion 111b and that of the portion, adjacent to the second identifying portion 111b, of the housing 111 may be 0.7-1.0 mm. Put simply, a ratio of the housing 111 at the second identifying portion 111b to the portion, adjacent to the second identifying portion 111b, of the housing 111 is ⅓-½.

On the other hand, a first identifying portion 111a corresponding to the second identifying portion is formed on the first surface to facilitate a user to identify an operation area corresponding to the position of the touch sensitive unit 130. As shown in FIG. 2c, a flange 111f is formed on the first surface 111c of the housing 11 and surrounding the first identifying portion 111a. The position of the flange 111f corresponds to the periphery of the second identifying portion 111b. Therefore, the position of the first identifying portion 111a corresponds to the position of the second identifying portion 111b. That is, the user can conveniently identify the operation area corresponding to the touch sensitive unit 130 by touching or seeing the flange 111f.

In an embodiment, the housing 111 may have a mark 160 formed, may be printed, on the first surface 111c that adjacent to first identifying portion 111a and facilitates identifying the first identifying portion 111a. The mark 160 may be a strip and be located in any two sides of the first identifying portion 111a as shown in the FIGS. 2l and 2m, or located in any one side of the second identifying portion 111b as shown in the FIG. 2n. Moreover, in another embodiment, the appearance of the mark 160 can be an arrow as shown in the FIG. 2o or dots formed on the first surface 111c as shown in FIG. 2p. The material, color, or texture of the mark 160 may be different from that of the housing 111. Therefore, a user can identify the first identifying portion 111a via touching or seeing the mark.

In another embodiment, as shown in FIG. 2g, the first identifying portion includes a plurality of identifying dots 150 that formed on the first surface of the housing and defines the operation area. The identifying dots 150 may be arranged in matrix on the first surface 111c. That is, the identifying dots 150 are used to identify the first identifying portion 111a and the operation area on the first surface 111c of the housing 111. Thus, a user can easily know the operation area and the position of the touch sensitive unit 130 by touching or seeing the identifying dots 150. The identifying dots 150 may be of specific shapes, including but not limited to, round shape or a triangle shape. The identifying dots may be protrusions, or indentations, that formed on the first surface.

Moreover, in another embodiment, as shown in FIG. 2h, the position of the touch sensitive unit 130 is identified by light from illumination elements 170 that disposed on the second surface 111d. FIG. 2i is a cross-section diagram from the line AA′ in the FIG. 2h. In this embodiment, the illumination elements 170 are embedded in the positions adjacent to the second identifying portion 111b on the second surface 111d. The thickness of the housing that the illumination elements 170 forms therein is thinned for the light from the illumination elements 170 to pass through the housing 111. That is, a user can see the light from the illumination elements 170 on the first surface 111c to identify the first identifying portion 111a. Therefore, the user can know the mounting position of the touch sensitive unit 130 based on the indication of the light from the illumination elements 170. In an embodiment, the illumination elements 170 are surrounding the second identifying portion 111b.

Moreover, in another embodiment, as shown in FIG. 2j, the position of the touch sensitive unit 130 is identified by forming a first part 172 that is made of thermochromic material to cover the touch sensitive unit 130 on the first surface 111c. The thermochromic material can be made as semi-conductor compounds, from liquid crystals or metal compounds. The color of the thermochromic material is changed when a determined temperature is reached. Therefore, in this embodiment, the thermochromic material is doped in the first part 172 of the first surface 111c. The first part 172 covers the touch sensitive unit 130. That is, the color of the first part 172 is changeable based on the temperature changing thereof when user's finger touches the first part 172. Otherwise, when the touch sensitive unit 130 is powered on, the temperature of the touch sensitive unit 130 is raised to a determined temperature, the color of the first part 172 is changed. By different color, the first identifying portion 111a is identified. Therefore, a user can know the identified position of the touch sensitive unit 130 based on the changed color.

In another embodiment, as shown in FIG. 2k, the housing 111 has a plurality of through holes 174 communicating the first identifying portion 111a and the second identifying portion 111b. An interface member 180 is disposed on the second surface 111d with a bottom surface couple with the touch sensitive unit 130 and a top surface attached to the second surface 111d. A plurality of exposed portions 180a on the top surface of the interface member 180 that corresponding to the through holes 174 pass through the through holes 174 and protrudes from the first surface 111c. With such manner, a user may touch the interface member 180 on the first identifying portion 111a, and force applied may transmitted to the sensitive unit 130 via the interface member 180. Therefore, a detection of a touch is enabled to the touch sensitive unit 130.

The display 120 is disposed on the main portion 110 in a rotatable manner to displays the information of the notebook computer 100. As stated above, the second identifying portion 111b is formed on the second surface 111d of the housing 111; and therefore does not face the display 120. The touch sensitive unit 130 is disposed in the second identifying portion 111b on the second surface 111d of the housing 111, to perform cursor movement and other interaction with the computer. As shown in FIG. 2a and FIG. 2b, the touch sensitive unit 130 is disposed in the main portion 110; in such a way that the main portion 110 is not exposed. Thus, before the touch sensitive unit 130 is disposed in the second identifying portion 111b, a protective film (not shown) can be removed from the touch sensitive unit 130. As a result, the thickness of the entire touch sensitive unit 130 can be reduced, and the sensitivity of the touch sensitive unit 130 can be enhanced.

Furthermore, referring to FIG. 2e, the notebook computer 100 further includes an adhesive member 140. The adhesive member 140 is located between the touch sensitive unit 130 and the housing 111, and the touch sensitive unit 130 is adhered to the housing 111. Thus, the touch sensitive unit 130 is closely adjacent to the housing 111 via the adhesive member 140 eliminating any gap therebetween. It is understood that the adhesive member 140 may be a double paper double sides adhesive.

The structure of the notebook computer 100 is described as above, and its manufacturing method is described as follows.

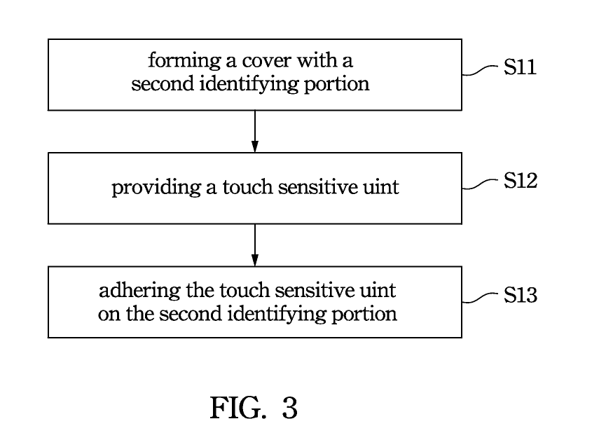

As shown in FIG. 3, a method, for manufacturing the notebook computer 100, includes the following steps. First, in step S11, a housing 111 with a second identifying portion 111 b as shown in FIG. 2d is formed. Then, in step S12, the touch sensitive unit 130 and the adhesive member 140 are provided. Finally, in step S13, the touch sensitive unit 130 is adhered on the second identifying portion 111b via the adhesive member 140 to eliminate any gap therebetween.

It is understood that the housing 111 may be formed by injection molding.

As stated above, since the touch sensitive unit is disposed in the main portion without forming an aperture or cutout at the housing, the housing to prevent water from entering the main portion. Furthermore, external dust cannot be deposited on the touch sensitive unit. Thus, the performance of the touch sensitive unit is optimized. In addition, since the second identifying portion is a concave structure, the combined thickness of the housing and the touch sensitive unit is less than that in a conventional notebook computer. Thus, the space inside the main portion of the notebook computer can be increased, and device arrangement inside the main portion is more flexible.

While the invention has been described by way of example and in terms of the preferred embodiment, it is to be understood that the invention is not limited to the disclosed embodiment. To the contrary, it is intended to housing various modifications and similar arrangements (as would be apparent to those skilled in the art). Therefore, the scope of the appended claims should be accorded the broadest interpretation so as to encompass all such modifications and similar arrangements.

What is claimed is:

1. A notebook computer, comprising:
a display;
a main portion connected with the display and including a housing, wherein the housing has a first surface and a second surface, a first identifying portion formed on the first surface and not exposed to the second surface and a second identifying portion corresponding to the first identifying portion formed on the second surface and not exposed to the first surface; and
a touch sensitive unit located in the second identifying portion.

2. The notebook computer as claimed in claim 1, wherein the second identifying portion is a concave structure formed on the second surface.

3. The notebook computer as claimed in claim 1, further has at least one holding protrusion formed on the second surface adjacent to the second identifying portion and engaging the touch sensitive unit.

4. The notebook computer as claimed in claim 1, wherein the first identifying portion includes a plurality of identifying dots that formed on the first surface of the housing and corresponding to the second identifying portion.

5. The notebook computer as claimed in claim 1, wherein at least a part of the first identifying portion is made of a thermochromic material.

6. The notebook computer as claimed in claim 1, wherein the first identifying portion is surrounded by a flange.

7. The notebook computer as claimed in claim 6, wherein the position of the flange corresponds to the periphery of the second identifying portion.

8. The notebook computer as claimed in claim 1, wherein the housing further have a mark formed on the first surface that adjacent to first identifying portion.

9. The notebook computer as claimed in claim 8, wherein the mark is a strip and be located in any two sides of the first identifying portion.

10. The notebook computer as claimed in claim 1, further comprising a plurality of illumination element disposed on the second surface.

11. The notebook computer as claimed in claim 10, the housing corresponding to the illumination elements form thereon is thinned for the light to pass through the housing.

12. A notebook computer, comprising:
a display;
a main portion connected with the display and including a housing, wherein the housing has a first surface, a second surface, a first identifying portion formed on the first surface, a second identifying portion corresponding to the first identifying portion formed on the second surface, and a plurality of through holes communicating the first identifying portion and the second identifying portion;
a touch sensitive unit disposed in the second identifying portion; and
an interface member disposed on the second surface and couple with the touch sensitive unit, and part of the interface member exposed through the through holes.

13. The notebook computer as claimed in claim 12, wherein the plurality of holes are arranged in lines or matrix.

14. The notebook computer as claimed in claim 12, further has at least one holding protrusion formed on the second surface adjacent to the second identifying portion and engaging the touch sensitive unit.

15. The notebook computer as claimed in claim 12, wherein the first identifying portion is made of a thermochromic material.

16. The notebook computer as claimed in claim 12, wherein the housing further have a mark formed on the first surface that adjacent to first identifying portion.

17. The notebook computer as claimed in claim 16, wherein the mark is a strip.
